(19) United States
(12) Patent Application Publication
(10) Pub. No.: US 2009/0192717 A1
(43) Pub. Date: Jul. 30, 2009

(54) METHODS AND APPARATUSES FOR DYNAMIC FILTERING OF GEOMETRIC PRIMITIVES IN 3D SPACE

(76) Inventors: Terje Iversen, Beijing (CN); QingRui Li, Beijing (CN); Randolph Pepper, Beiling (CN)

Correspondence Address: Spencer K. Warnick;Hoffman, Warnick & D'Alessandro, LLC, 14th Floor, 75 State Street, Albany, NY, 12207, US

(21) Appl. No.: 12/019,351

(22) Filed: Jan. 24, 2008

(51) Int. Cl. G01V 1/34; G01V 1/40

(52) U.S. Cl. 702/11; 702/16

(57) ABSTRACT

Methods and systems for investigating subterranean formations are disclosed. A method for investigating subterranean formations includes obtaining formation property data for a volume of interest in the subterranean formation s; presenting the formation property data as a collection of objects in a three-dimensional volume that represents the volume of interest; filtering the collection of objects based on proximity to a reference point and a selected property associated with a subset of the collection of objects; and displaying objects that satisfy the proximity to the reference point and the selected property.

### BACKGROUND OF INVENTION

1. Field of the Invention

This invention relates to the field of data interpretation. In particular, the invention relates to an apparatus and method for selecting and displaying a subset of spatial data, such as a three-dimensional volume of seismic data.

2. Background Art

Seismic data acquisition and processing are key components in geophysical exploration. In a seismic survey, acoustic waves are generated by a source at the Earth's surface, for example, and the waves are radiated into the Earth's subsurface. As the waves radiate downward through the Earth's subsurface, they reflect and propagate upwards towards the surface whenever the subsurface medium changes. The upward reflections are detected by a number of receivers and the reflected data recorded and processed in order to image the subsurface.

FIG. 1 illustrates a typical seismic survey system. As shown in FIG. 1, a seismic source 102 such as a vibrator truck, a small explosion, or an air gun (in underwater surveys), generates seismic waves that propagate through subsurface formations 104. As shown by a selected propagation path 106, the seismic waves reflect and refract at boundaries between subsurface formations 104, and eventually some of the reflected seismic waves reach an array of receivers 108. The array typically includes hundreds of receivers 108 spaced in a grid pattern. Receivers 108 convert seismic waves into electrical signals that are then recorded at a recording facility 110 such as a recorder truck. Eventually the recorded data is transported or transmitted to a central facility 112 for analysis.

Interpretation of these acoustic/seismic data of the subsurface formation leads to the structural description of the subsurface geological features, such as faults, salt domes, anticlines, or other features indicative of hydrocarbon traps. Because these geological features are often associated with hydrocarbon reservoirs, it is important to have methods that can accurately and easily identify these features.

For example, faults in subterranean formations create hydrocarbon traps and flow channels. Therefore, accurate identification of the fault curves and fault surfaces is essential for the interpretation of most seismic data volumes. Operators involved in the identification of such hydrocarbon traps and flow channels in the formations typically use an interactive workstation to display sections of seismic data. The seismic data includes a plurality of fault curves or fault cuts, each of which represents an intersection of a fault surface with a “horizon” deduced from the seismic data.

However, when using existing workstation tools that include interactive computer programs, the interpretation of fault cuts on horizons in the seismic data is tedious and time consuming. Typically, the operator would view the seismic data volume on the workstation display, manually determine (by viewing the seismic data) where the horizons are located in the seismic data, and manually determine (by viewing the plurality of horizons) where the fault cuts are located in the horizons.

To automate this process various approaches have been proposed. The current methods for horizon interpretation of 3D seismic volumes consists of a computer program that auto-tracks a signal consistent event based on user-defined criteria and user provided “seed” points, from which to grow the surface.

For example, U.S. Pat. No. 5,537,320 issued to Simpson et al. discloses a method for automatically determining where faults are located in the horizons in seismic data. According to this method, a seed fault is placed by a user in the seismic data, and a plurality of fault curves are determined by a computer program in response to the seed fault placed by the user in the seismic data.

U.S. Pat. No. 6,201,884 issued to van Bemmel et al. discloses a method for testing a plurality of displayed data points of spatial data to determine trends created by different sets of the data points within the recorded spatial data. With this method, a user define: (a) a point in the displayed seismic data volume that is to be automatically searched for the identification and display of a particular fault trace within the seismic data volume; (b) the direction(s) in which the search, identification, and display of a particular fault trace within the seismic data volume should be performed; (c) the distance within which the search for adjacent fault contact points in the seismic data volume; and (d) the angle about the chosen search direction in which the search, identification, and display of a particular fault trace within the seismic data volume should be performed.

U.S. Pat. No. 7,203,342 issued to Pedersen discloses a method for extracting desired features from a cellular image including the steps of: (a) selecting an initial cell within the image; (b) selecting an additional cell, near the initial cell, appearing to be associated with a desired feature; (c) repeating step (b) for further cells, near at least one of the previously selected cells, appearing to be associated with said feature, until selection termination criteria are satisfied; and (d) repeating steps (a) through (c) for other initial cells. The method is particularly adept at extracting relatively weakly defined features in relatively noisy images, such as extracting faults or geologic horizons from 2D or 3D seismic data.

Similarly, a pending U.S. patent application Ser. No. ______ entitled, “Method And Apparatus For Dynamic Region Growing In 3D Voxel Volumes,” filed on Dec. 15, 2006 by Andersen et al. discloses a paintbrush-style “smart grower,” which is an interactive/semiautomatic tool, to do geobody segmentation. The user guides automatic segmentation by moving a 3D paintbrush object over seismic amplitude or attribute voxels. The paintbrush object has controls for brush volume, softness, and time-dependent saturation during user manipulation of the tool (similar to a spray can tool in pixel painting programs).

More recently, Schlumberger's Stavanger Research group developed methods to perform a pre-interpretation step to extract signal consistent horizon “patches” based only on user-defined criteria in a global extraction method to produce a set of valid sub-horizons that match the extraction criteria. These are called geometric primitives. In addition, tools for selectively filtering a sub-set of geometric primitives from the global volume have also been developed.

U.S. Pat. No. 7,248,539 issued to Borgos discloses a method for extrema classification, i.e., automated extraction of surface primitives from seismic data. The method includes defining, typically with sub-sample precision, positions of seismic horizons through an extrema representation of a 3D seismic input volume; deriving coefficients that represent the shape of the seismic waveform in the vicinity of the extrema positions; sorting the extrema positions into groups that have similar waveform shapes by applying classification techniques with the coefficients as input attributes using unsupervised or supervised classification based on an underlying statistical class model; and extracting surface primitives as surface segments that are both spatially continuous along the extrema of the seismic volume and continuous in class index in the classification volume. Three primary applications of the surface primitives are described: combining surface primitives into complete horizon interpretations; defining closed volumes within the seismic volume as the closure of vertically arranged surface primitives; or estimating fault displacement based on the surface primitives. See also, Borgos et al., “Automated Structural Interpretation Through Classification of Seismic Horizons,” in Armin Iske and Trygve Randen (eds.), Mathematical Methods and Modelling in Hydrocarbon Exploration and Production, Springer Verlag, Berlin/Heidelberg, D E, 2005, pp. 89-106; and Sonneland et al., “Automated geometry extraction from 3D seismic data by lateral waveform,” In Ext. Abstr. EAGE, Paris, June 2004.

These convention methods are useful in generating geometric primitives. However, there still exists a need for methods and systems that would allow a user to more easily extract useful information from these geometric primitives.

### SUMMARY OF INVENTION

In one aspect, the present invention relates to methods for investigating subterranean formations. A method in accordance with one embodiment of the invention includes obtaining formation property data for a volume of interest in the subterranean formations; presenting the formation property data as a collection of objects in a three-dimensional volume that represents the volume of interest; filtering the collection of objects based on proximity to a reference point and a selected property associated with a subset of the collection of objects; displaying objects that satisfy the proximity to the reference point and the selected property. The collection of objects may be seismic horizons. The proximity to the reference point may be defined by a proximity volume, which may have any geometric shape, such as a sphere, an elliptical sphere, a cube, a rectangular volume, or the like. In some embodiments, the proximity volume may have a shape of a previously defined seismic horizon as a conformal guide, i.e., a volume having a shape mimicking a seismic horizon. Note that the proximity filtering and the property filtering may be performed in real time, i.e., the display is automatically updated when a user changes one or more criteria (e.g., the reference point, the proximity volume shape, or object property).

In another aspect, the present invention relates to systems for analyzing formation property data. A system in accordance with one embodiment of the invention includes a processor and a memory, wherein the memory stores a program having instructions for: presenting the formation property data as a collection of objects in a three-dimensional volume; filtering the collection of objects based on proximity to a reference point and a selected property associated with a subset of the collection of objects; and displaying objects that satisfy the proximity to the reference point and the selected property. The collection of objects may be seismic horizons. The proximity to the reference point may be defined by a proximity volume, which may have any geometric shape, such as a sphere, an elliptical sphere, a cube, a rectangular volume, or the like. In some embodiments, the proximity volume may have a shape of a previously defined seismic horizon as a conformal guide, i.e., a volume having a shape mimicking a seismic horizon. Note that the proximity filtering and the property filtering may be performed in real time, i.e., the display is automatically updated when a user changes one or more criteria (e.g., the reference point, the proximity volume shape, or object property).

Another aspect of the invention relates to a computer-readable medium storing a program having instructions for: presenting the formation property data as a collection of objects in a three-dimensional volume; filtering the collection of objects based on proximity to a reference point and a selected property associated with a subset of the collection of objects; and displaying objects that satisfy the proximity to the reference point and the selected property.

Other aspects and advantages of the invention will become apparent from the following description and the attached claims.

### BRIEF SUMMARY OF THE DRAWINGS

FIG. 1 shows a conventional seismic logging system.

FIG. 2 shows a 3D volume having a collection of geometric primitives, such as seismic primitives.

FIG. 3 shows a process of dynamically filtering a collection of geometric primitives based on a proximity filter and a property filter in accordance with one embodiment of the invention.

FIG. 4 shows a display of a subset of geometric primitives from those shown in FIG. 2 that satisfy a proximity filter (shown as a sphere) in accordance with one embodiment of the invention.

FIG. 5A shows a schematic illustrating a mouse as an input device for controlling a cursor in a 3D coordinate.

FIG. 5B shows a filtered volume as in FIG. 4 with the 3D coordinate of the proximity volume displayed.

### DETAILED DESCRIPTION

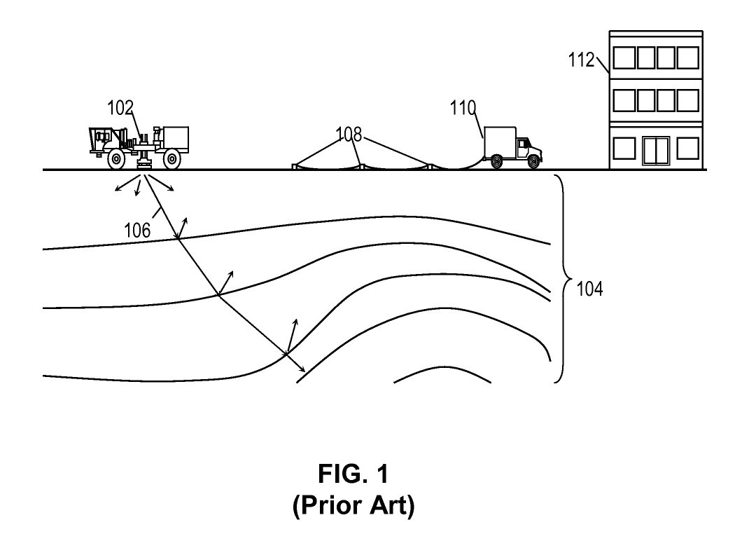

Embodiments of the invention relate to methods and systems for data processing, particularly data represented in three dimensions (3D). Embodiments of the invention are particularly useful in processing data obtained from oil and gas exploration, such as seismic prospecting. For clarity, the following description may use data form a seismic prospecting (such as that illustrated in FIG. 1) to illustrate embodiments of the invention. However, one of ordinary skill in the art would appreciate that embodiments of the invention may also be applied to other types of data.

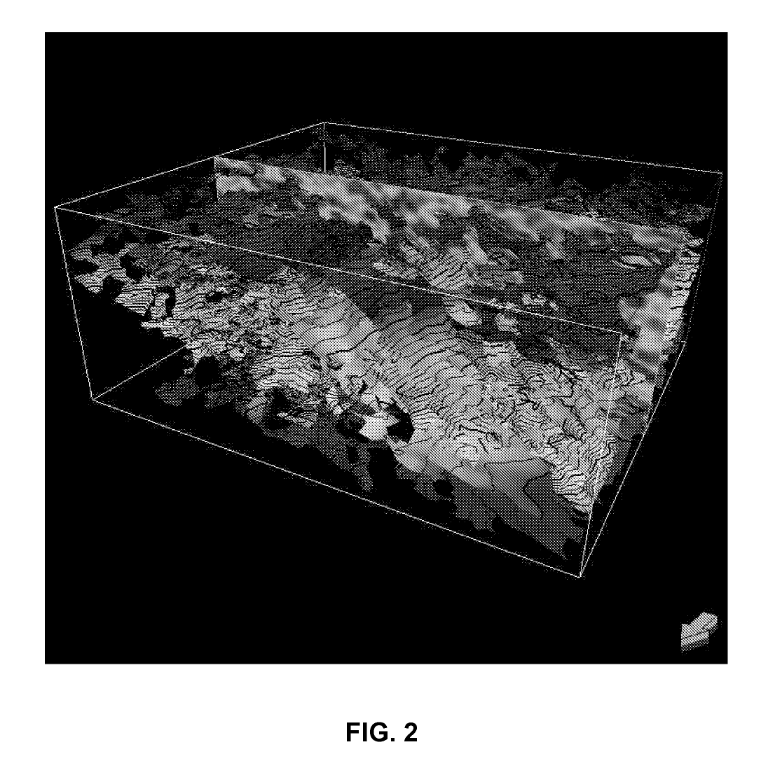

FIG. 2 shows an example of a seismic volume containing a collection of geometric primitives (such as seismic horizon patches). It is clear from FIG. 2 that seismic data are voluminous and very complicated. It is not easy to identify relevant geological features from such data.

Embodiments of the invention provide methods to facilitate the analysis of complicated 3D data, such as the seismic primitive data shown in FIG. 2. Methods of the invention represent an improvement over existing visual filtering method (such as that disclosed in U.S. Pat. No. 7,242,402 issued to Betting et al.) because methods of the invention provide interactive proximity filtering of the geometric primitives in 3D space; the interactivity may be based on a proximity criterion and/or a property criterion. A user can control the proximity tolerance and shape, as well as honoring pre-computed properties of the primitives. In addition, methods of the invention provide a novel method for positioning the filtering proximity operator in the three-dimensional coordinates, using commercial pointing devices.

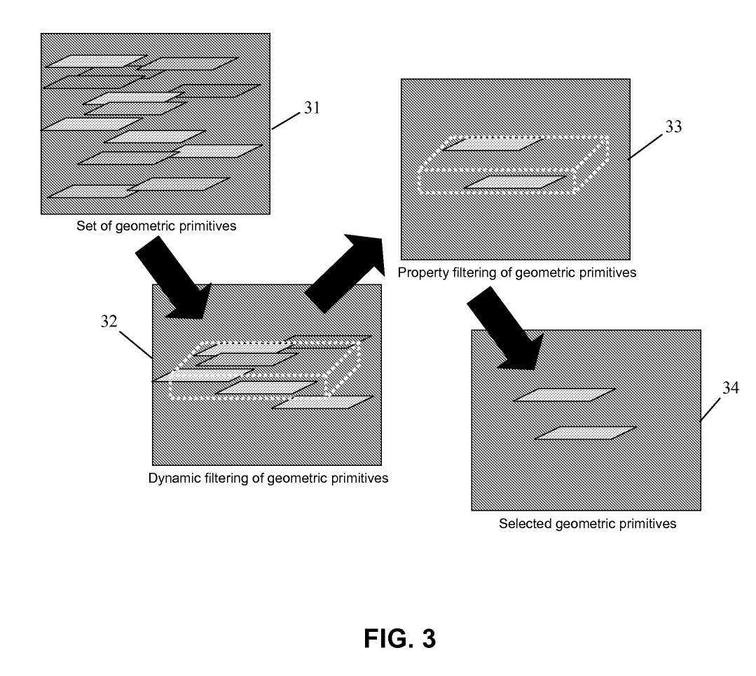

Embodiments of the invention relate to interactive graphical techniques for the isolation and selection of geometric primitives rendered in a 3D graphic canvas on a computer workstation. As shown in FIG. 3, a method or workflow in accordance with one embodiment of the invention can be described as beginning with a collection of objects or geometric primitives (step 31), which may or may not have been pre-computed. The collection of geometric primitives may be seismic horizons, geobodies, or other objects with associated properties.

A user may then dynamically filter (visually render or remove) the collection of geometric primitives (step 32). The dynamic filter may be based on the three-dimensional position of a reference point and the volumetric extent of a proximity filter. In accordance with embodiments of the invention, a proximity filter may have any shape, including a cube, a square block, a sphere, an elliptical sphere, a polyhedron, etc. The dynamic filtering produces a subset of the original collection of geometric primitives.

The user may further select or multi-select a desired subset of geometric primitives from the dynamically filtered collection. In addition to spatial filtering based on the proximity of the primitive to a 3D cursor position (i.e., a reference point), the user can further filter which geometric primitives to render/remove (step 33), based on pre-computed properties associated with the primitives (such as size, average value, etc.). Finally, the geometric primitives (or other objects) that meet the criteria of the proximity filter and the property filter may be displayed for real time analysis or save to a file for later analysis (step 34). Note that the order of steps 32 and 33 may be reversed, or these two steps may be performed simultaneously. Furthermore, the user may further select a second or more property criteria to further filtering (narrow down) the displayed objects to facilitate the analysis.

In accordance with embodiments of the invention, a method starts with a collection of geometric primitives (referring to FIG. 3). Geometric primitives may be defined as a collection of connected point sets. In the art of automated seismic interpretation, these primitives are derived from seismic data directly or from seismic attribute volumes. One such method is called horizon auto-tracking. In this method, the user will create a “seed point” within the seismic volume and the auto-tracking program will extend from this seed point based on user-defined expansion criteria (similar signal shape, similar amplitude, cross-correlation coefficient above threshold value for example). Several of these methods are described above.

In accordance with embodiments of the invention, a more sophisticated approach will extract all geometric primitives within a 3D space or sub-volume from that space based on user-defined criteria. This global extraction method can produce hundreds to thousands of primitives. These global methods have been demonstrated for extraction of geologic horizons, geologic fault systems, and geologic bodies (sand channels, stratigraphic facies, salt bodies, etc.). The current state-of-the-art allows the rendering and visual filtering of these collections based on properties associated with each geometric primitive in a collection, i.e., size, areal extent, identification index, average value, and other computed properties.

Method of the present invention may perform dynamic filtering of these geometric primitive collections based on the proximity distance to a three-dimensional cursor position, in addition to property filtering described above. The proximity distance may be controlled by the shape of a proximity filter, which is user controllable, for example, a spherical or ellipsoidal geometry, a rectangular volume with orientation control, or a computed surface with a defined thickness (structurally oriented surface such as a seismic horizon). Geometric primitives are rendered when the spatial position of the primitive intersects the three-dimensional position of the proximity filter, and the criteria for property filtering are satisfied. In addition, objects selected by the user (a mouse button click on the object, for example) may also remain visible even if outside the proximity volume so that the user can work with them easily.

The example in FIG. 2 shows a geometric primitive collection of horizon patches without any property or proximity filtering. The interpreter's objective would be to identify and/or merge those primitives that are geologically related (same formation boundary). Methods of the invention may use data that have been previously logged or data that are being logged, i.e., a method of the invention may or may not include a logging step.

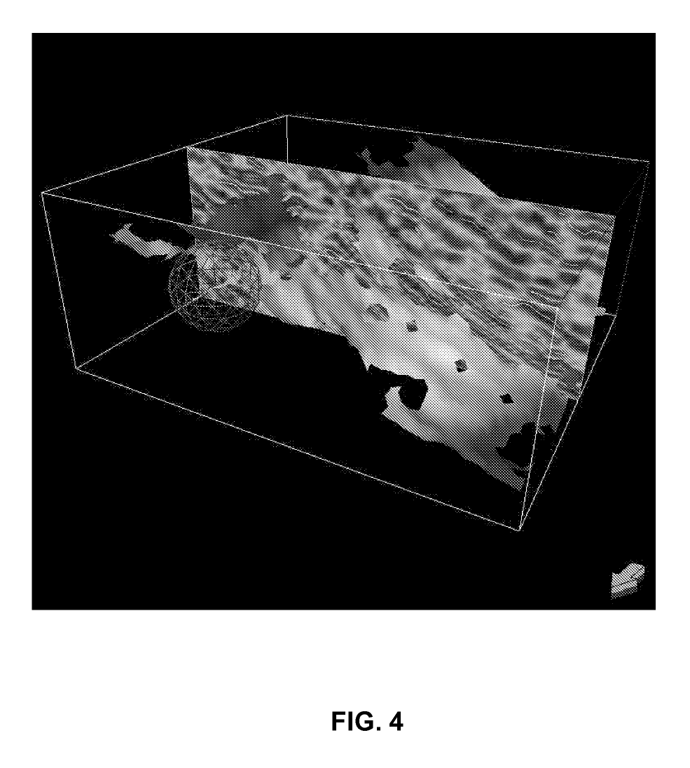

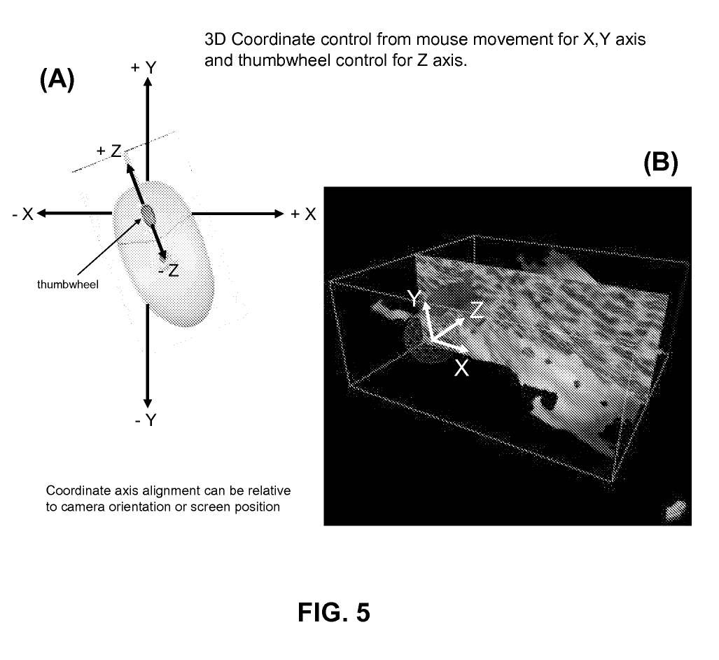

FIG. 4 shows a dynamic filter selectively rendering those primitives that intersect the 3D proximity volume. For this example, the proximity volume is a sphere. However, one of ordinary skill in the art would appreciate that any suitable shape may be used. The user may be allowed to manipulate the proximity filter using a conventional input device for a computer such as a mouse or keyboard. For example, movement of the cursor will change the X,Y center position of the proximity filter, and the forward or backward motion of the thumbwheel will change the Z position, as described below. In accordance with embodiments of the invention, the 3D view may be automatically updated (e.g., in real time) to reflect the geometric primitives that intersect the proximity volume at it's new position, while those primitives which no longer intersect will be hidden.

In accordance with embodiments of the invention, the center of the proximity volume may be dynamically positioned using a pointing device, such as a mouse with a thumbwheel, a six-degree of freedom gaming device, or keyboard control. One possible method of moving the cursor position in three-dimensional space may be defined as follows: Z is the distance from the camera to a plane parallel to the screen plane in space; the X, Y position is on the plane; and the projected location on the screen follows the mouse position. In accordance with embodiments of the invention, geometric primitives that no longer have a geometric intersection with the proximity volume will be removed (not displayed) from the scene, while new geometric primitives that now intersect the proximity volume at the new position will be rendered in the scene. This displaying or non-displaying may be performed automatically in response to a change in the reference point and/or proximity shape such that it would appear that these changes occur in real time.

Rendered geometric primitives can be selected using traditional selection or multi-selection operations from the cursor position at the center of the proximity volume. The user can use a “proximity” selection to select all rendered primitives within the proximity volume. As mentioned, user-selected objects can remain visible even if they are outside of the proximity volume. A method for selection in 3D object is disclosed in U.S. Pat. No. 7,103,499 issued to Goodwin et al., which discloses a method for 3D selection and manipulation with a multiple dimension haptic interface. Once selected, the geometric primitives are available for further operations, such as merging, smoothing, editing, etc.

Some embodiments of the invention relate to systems that implement the above described methods. A system of the invention may include a processor and a memory that store a program having instructions for causing the processor to perform the steps of a method of the invention. Such systems may be implemented on any computer (such as a personal computer or workstation) or any computing unit known in the art. Some embodiments of the invention relate to computer readable media, which store a program having instructions for causing the processor to perform the steps of a method of the invention.

Advantages of the invention may include one or more of the following. Methods of the invention use dynamic filtering of a large collection of geometric primitives to quickly isolate a desired subset of available geometric primitives. The filtering may be based on proximity to a selected point in 3D as well as a selected property of the object. This will facilitate analysis of complex data set to afford quick identification of useful information.

While the invention has been described with respect to a limited number of embodiments, those skilled in the art, having benefit of this disclosure, will appreciate that other embodiments can be envisioned that do not depart from the scope of the invention as disclosed herein. Accordingly, the scope of the invention shall be limited only by the attached claims.

What is claimed is:

1. A method for investigating subterranean formations, comprising:
obtaining formation property data for a volume of interest in the subterranean formations;
presenting the formation property data as a collection of objects in a three-dimensional volume that represents the volume of interest;
filtering the collection of objects based on proximity to a reference point and a selected property associated with a subset of the collection of objects; and
displaying objects that satisfy the proximity to the reference point and the selected property.

2. The method of claim 1, wherein the proximity to a reference point is defined by a proximity volume.

3. The method of claim 2, wherein the proximity volume has a shape selected from the group consisting of a sphere, an elliptical sphere, a cube, a rectangular volume, and a volume having a shape mimicking a predefined seismic horizon.

4. The method of claim 1, wherein the filtering and the displaying are automatically updated in response to a change in the reference point or the selected property.

5. The method of claim 1, wherein the formation property data are seismic data.

6. The method of claim 5, wherein the collection of objects are seismic horizons.

7. The method of claim 1, wherein the obtaining the formation property data comprises performing logging in a well using a downhole tool.

8. The method of claim 1, further comprising analyzing the displayed objects to derive a parameter related to the formation property data.

9. The method of claim 2, further comprising:
displaying a user-selected object outside the proximity volume.

10. A system for analyzing formation property data, comprising a processor and a memory, wherein the memory stores a program having instructions for:
presenting the formation property data as a collection of objects in a three-dimensional volume;
filtering the collection of objects based on proximity to a reference point and a selected property associated with a subset of the collection of objects; and
displaying objects that satisfy the proximity to the reference point and the selected property.

11. The system of claim 10, wherein the proximity to a reference point is defined by a proximity volume.

12. The system of claim 11, wherein the proximity volume has a shape selected from the group consisting of a sphere, an elliptical sphere, a cube, a rectangular volume, and a volume having a shape mimicking a predefined seismic horizon.

13. The system of claim 10, wherein the formation property data are seismic data.

14. The system of claim 13, wherein the collection of objects are seismic horizons.

15. The system of claim 13, wherein the program further comprising instructions for obtaining the seismic data using a seismic tool.

16. The system of claim 10, wherein the program further comprising instructions for analyzing the displayed objects to derive a parameter related to the formation property data.

17. A computer-readable medium storing a program having instructions for:
presenting the formation property data as a collection of objects in a three-dimensional volume;
filtering the collection of objects based on proximity to a reference point and a selected property associated with a subset of the collection of objects; and
displaying objects that satisfy the proximity to the reference point and the selected property.

18. The computer-readable medium of claim 17, wherein the proximity to a reference point is defined by a proximity volume.

19. The computer-readable medium of claim 18, wherein the proximity volume has a shape selected from the group consisting of a sphere, an elliptical sphere, a cube, and a rectangular volume.

20. The computer-readable medium of claim 17, wherein the collection of objects are seismic horizons.
